(19) United States
(12) Patent Application Publication
(10) Pub. No.: US 2017/0037873 A1
(43) Pub. Date: Feb. 9, 2017

(54) IMPELLER REMOVER

(71) Applicant: V & L Engineering, Kalama, WA (US)

(72) Inventors: Gary Curtis VanWinkle, Kalama, WA (US); Jonathan Goforth Lichty, Westport, WA (US); Benjamin Michael Lichty, Westport, WA (US)

(21) Appl. No.: 14/819,234

(22) Filed: Aug. 5, 2015

(51) Int. Cl. F04D 29/60; B23P 19/04

(52) U.S. Cl. CPC F04D 29/601; F04D 29/605; B23P 19/04

(57) ABSTRACT

An impeller removal tool can include a frame having a central portion and a first arm connected to the central portion and extending therefrom. The frame can include a second arm connected to the central portion and extending therefrom. The tool can include an actuation portion movably connected to the central portion of the frame, the actuation portion configured to engage with an axle of an impeller assembly. The tool can include a first jaw having a first coupling portion configured to movably connect to the first arm of the frame. The first jaw can include a second coupling portion configured to movably connect to the second arm of the frame. The first jaw portion can be connected to both the first coupling portion and to the second coupling portion, the first jaw portion configured to fit at least partially between two walls of an impeller.

### TECHNICAL FIELD

Certain embodiments discussed herein relate to tools for removing impellers from industrial fluid transfer systems such as, for example, oil drilling systems.

### DISCUSSION OF THE RELATED ART

Impellers are used in industrial application to facilitate movement of liquids and other fluids. Repairing or replacing impellers often requires removal of the impeller from the axle or other structure to which the impeller is connected. In some cases, pry bars and hammers are used to physically remove the impellers. This process is often very difficult and often results in damage and/or ruin of the impellers.

### SUMMARY

An impeller removal tool can include a frame. The frame can include a central portion. In some embodiments, the frame includes a first arm connected to the central portion and extending therefrom. The frame can include a second arm connected to the central portion and extending therefrom. The tool can include an actuation portion. The actuation portion can be movably connected to the central portion of the frame. In some embodiments, the actuation portion is configured to engage with an axle of an impeller assembly. The tool can include a first jaw. The first jaw can include a first coupling portion. The first coupling portion can be configured to movably connect to the first arm of the frame. In some embodiments, the first jaw includes a second coupling portion. The second coupling portion can be configured to movably connect to the second arm of the frame. The first jaw can include a first jaw portion connected to both the first coupling portion and to the second coupling portion. The first jaw portion can be configured to fit at least partially between two walls of an impeller and to impart a force on a wall of an impeller to remove an impeller from an axle of an impeller assembly.

In some configurations, the frame comprises a third arm connected to the central portion and extending therefrom. In some cases, the frame includes a fourth arm connected to the central portion and extending therefrom. In some embodiments, the impeller removal tool comprises a second jaw. The second jaw can include a third coupling portion configured to movably connect to the third arm of the frame. In some embodiments, the second jaw includes a fourth coupling portion configured to movably connect to the fourth arm of the frame. The second jaw can include a second jaw portion connected to both the third coupling portion and to the second coupling portion. The second jaw portion can be configured to fit at least partially between two walls of an impeller and to impart a force on a wall of an impeller to remove an impeller from an axle of an impeller assembly.

In some configurations, the central portion of the frame includes a threaded opening. In some configurations, the actuation portion comprises a threaded rod portion configured to threadedly engage with the threaded opening of the central portion of the frame.

In some configurations, the frame comprises an “H” shape, the first, second, third, and fourth arms extending perpendicularly from a length of the central portion.

In some configurations, the first and third arms are collinear and the second and fourth arms are collinear.

In some configurations, first and second coupling portions are configured to connect to the first and second arms, respectively, in at least a first position and a second position. In some configurations, the first jaw portion is positioned closer to the center portion of the frame in the first position than in the second position.

In some configurations, the third and fourth coupling portions are configured to connect to the first and second arms, respectively, in at least a first position and a second position. In some configurations, the second jaw portion is positioned closer to the center portion of the frame in the first position than in the second position.

In some configurations, the first and second arms each comprise a hollow bar.

In some configurations, the third and fourth arms each comprise a hollow bar.

According to some variants, an impeller remover tool includes an actuation portion. The actuation portion can include an elongate body having a first end, a second end, and a length therebetween. In some embodiments, the actuation portion includes a head on the first end of the elongate body. The tool can include a frame. The frame can include a hub. In some embodiments, the frame includes a first arm connected to and extending from the hub. In some cases, the frame includes a second arm connected to the hub and extending from the hub. In some embodiments, the frame includes a connection interface connected to the hub and configured to mate with a portion of the elongate body of the actuation portion. The tool can include a first engagement portion. The first engagement portion can include a first mating arm configured to mate with the first arm of the frame. In some embodiments, the first engagement portion includes a first grasping portion configured to grasp at least a portion of an impeller. The first engagement portion can include a first spacer connected to the first mating arm and to the first grasping portion. The first spacer can be configured to distance the first grasping portion from the first mating arm in a direction parallel to the length of the elongate body of the actuation portion. The tool can include a second engagement portion. The second engagement portion can have a second mating arm configured to mate with the second arm of the frame. In some embodiments, the second engagement portion includes a second grasping portion configured to grasp at least a portion of an impeller. In some cases, the second engagement portion includes a second spacer connected to the second mating arm and to the second grasping portion. The second spacer can be configured to distance the second grasping portion from the second mating arm in a direction parallel to the length of the elongate body of the actuation portion. In some embodiments, each of the first and second grasping portions has a width measured in a direction perpendicular to both the length of the elongate body and to the first arm of the frame. In some cases, the width of each of the first and second grasping portions is greater than one half of a width of the removal tool in a direction parallel to the first arm when the removal tool is attached to an impeller.

In some configurations, the tool includes a third arm connected to and extending from the hub in a direction parallel to the first arm, wherein the first spacer is connected to the third arm.

In some configurations, the tool includes a fourth arm connected to the hub and extending from the hub in a direction parallel to the second arm, wherein the second spacer is connected to the fourth arm.

In some configurations, the first grasping portion is formed by bending the first spacer.

In some configurations, the first grasping portion is a flattened plate.

In some configurations, the first arm comprises a pair of collinear holes extending therethrough.

In some configurations, the first mating arm comprises a pair of collinear holes extending therethrough.

In some configurations, the tool includes a pin extending through the pairs of collinear holes in both the first arm and the first mating arm.

In some configurations, the pin inhibits movement of the first arm with respect to the first mating arm in a direction parallel to the first arm.

In some configurations, the first and second grasping portions are each configured to fit between a front vane and a back vane of an impeller.

In some configurations, the second end of the elongate body of the actuation portion is configured to contact an axel of an impeller when the remover tool is installed on an impeller.

An impeller removal system can include any of the impeller removal tools described above. In some embodiments, the system includes a wedging device. The wedging device can include a wedging frame defining a perimeter of the wedging device. The wedging device can include a first wedge member connected to the wedging frame. In some embodiments, the wedging device includes a first wedge actuation portion having a first end, a second end, and a length therebetween. In some cases, the wedging device includes a wedging portion connected to the second end of the first wedge actuation portion. In some embodiments, the wedging portion is configured to fit behind a back vane of an impeller before or during removal of an impeller from an axel. The wedging portion can have a sloped surface. In some cases, the wedging device includes a second wedge member connected to the wedging frame. The second wedge member can include a second wedge actuation portion having a first end, a second end, and a length therebetween. The second wedge member can include a wedging portion connected to the second end of the second wedge actuation portion. In some embodiments, the wedging portion is configured to fit behind a back vane of an impeller before or during removal of an impeller from an axel, the wedging portion having a sloped surface.

### BRIEF DESCRIPTION OF THE DRAWINGS

The present disclosure is described with reference to the accompanying drawings, in which like reference characters reference like elements, and wherein:

FIG. 1 is a schematic illustration of an impeller remover device.

FIG. 2 is a perspective view of an impeller remover device.

FIG. 3 is a front view of the device of FIG. 2.

FIG. 4 is a left side view of the device of FIG. 2

FIG. 5 is a top view of the device of FIG. 2.

FIG. 6 is a perspective view of an attachment member.

FIG. 7 is a perspective view of the device of FIG. 2 installed on an impeller.

FIG. 8 is a cross-sectional view of the device of FIG. 2 installed on an impeller, as viewed in cut plane 8-8 of FIG. 7.

FIG. 9 is a top view of the device of FIG. 2 installed on an impeller.

FIG. 10 is a perspective view of a wedging device.

FIG. 11 is a cross-sectional view of the device of FIG. 10 along the cut plane 11-11 of FIG. 10.

FIG. 12 is a close up cross-sectional view of the device of FIG. 10 along the cut plane 11-11 of FIG. 10.

### DETAILED DESCRIPTION OF THE INVENTION

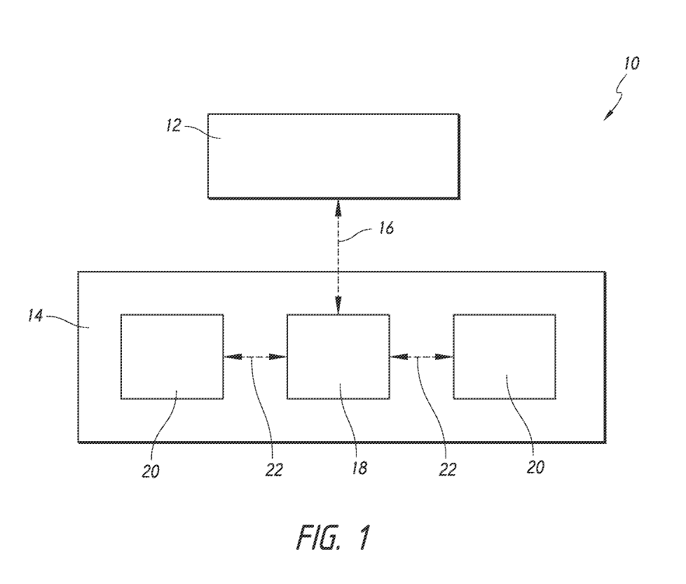

An embodiment of an impeller remover device 10 is illustrated in FIG. 1. As illustrated, the device 10 can include an actuation portion 12. In some cases, the actuation portion 12 is configured to receive user input to actuate the remover device 10. The device 10 can include an engagement portion 14. The engagement portion 14 can be configured to engage with or otherwise interact with an impeller or other mechanism (hereinafter summarized as an impeller). The actuation portion 12 can be connected (e.g., releasably, moveably, fixedly, and/or removably) to the engagement portion 14 via a connection interface 16. The connection interface 16 can be, for example, threaded engagement, frictional engagement, or some other engagement method and/or mechanism. In some embodiments, actuation of the actuation portion 12 when the engagement portion 14 is engaged with an impeller moves the impeller and the engagement portion 14 with respect to the actuation portion 12.

As illustrated in FIG. 1, the engagement portion 14 can include a hub or frame 18. The frame 18 can be configured to connect or engage with the impeller to be removed. In some embodiments, the engagement portion 14 includes one or more attachment members 20. The one or more attachment members 20 can be connected to the frame 18 via one or more attachment interfaces 22. For example, the one or more attachment member 20 can be connected to the frame 18 via threading, one or more pins, fasteners, friction fitting, and/or other connection mechanisms or methods. In some embodiments, the one or more attachment members 20 are adjustable with respect to the frame 18 and/or with respect to each other to accommodate various sizes of impellers.

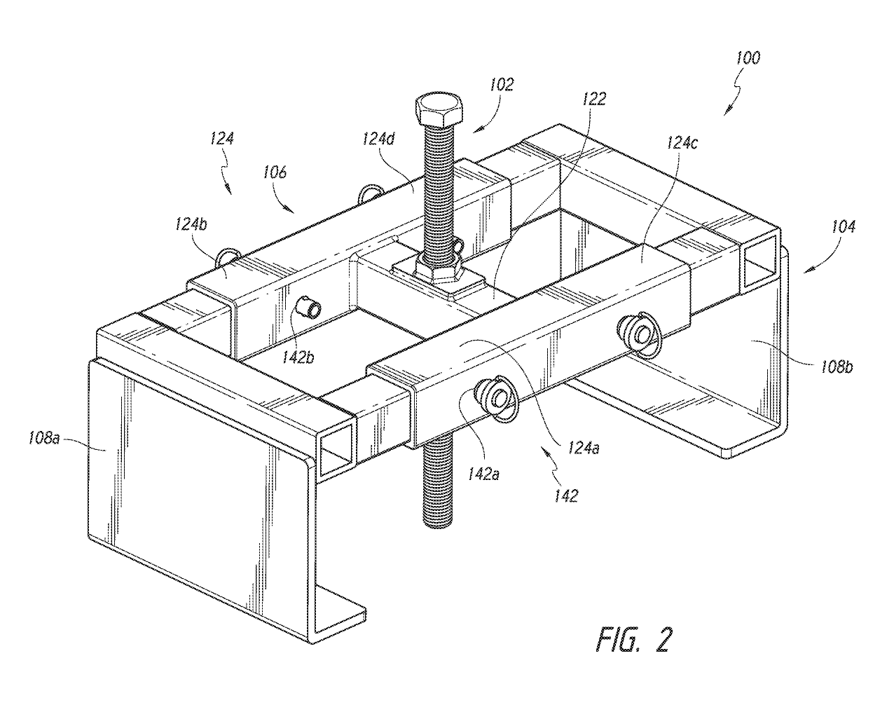

FIGS. 2-5 illustrate an embodiment of an impeller remover device 100. The device 100 can include an actuation portion 102. The actuation portion 102 can be connected to an engagement portion 104. As illustrated, the engagement portion 104 can include a frame 106. In some embodiments, the engagement portion 104 includes one or more attachment members 108a, 108b. For example, as illustrated, the engagement portion 104 can include two attachment members 108a, 108b connected to the frame 106.

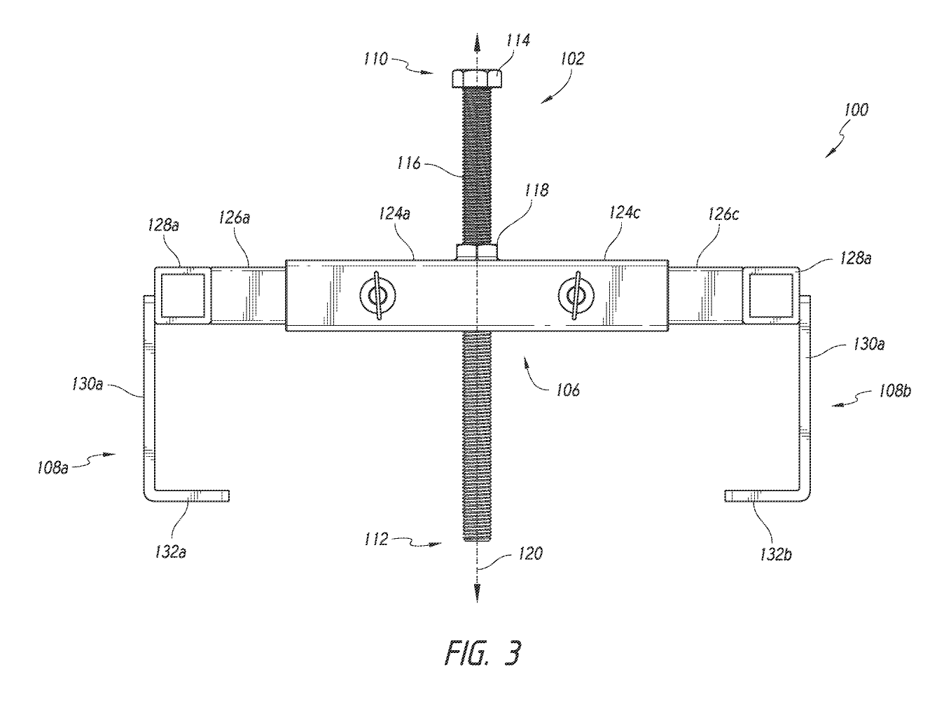

As illustrated in FIG. 3, the actuation portion 102 can be a rod or other elongate structure. The actuation portion 102 can have a first end 110 and a second end 112. In some embodiments, the actuation portion 102 includes a head 114 or other engageable feature. The head 114 can be positioned at or near the first end 110 of the actuation portion 102. In some embodiments, the head 114 is positioned along a length of the actuation portion 102 between the first and second ends 110, 112 of the actuation portion 102. As illustrated, the head 114 can be a hex head or other structure configured to connect with a tool (e.g., a wrench, drill bit, power tool, pneumatic tool, or otherwise).

At least a portion of the length of the actuation portion 102 can be threaded. For example, external threads 116 can be included on at least 20%, at least 35%, at least 50%, at least 75%, and/or on at least 95% of the length of the actuation portion 102.

The frame 106 can include a connection interface 118 configured to connect to the actuation portion 102. For example, the connection interface 118 can include internal threading configured to threadedly engage with the external threads 116 of the actuation portion 102. Rotation of the actuation portion 102 about an actuation axis 120 (e.g., an axis through the length of the actuation portion 102) can move the actuation portion 102 with respect to the frame 106 along the actuation axis 120.

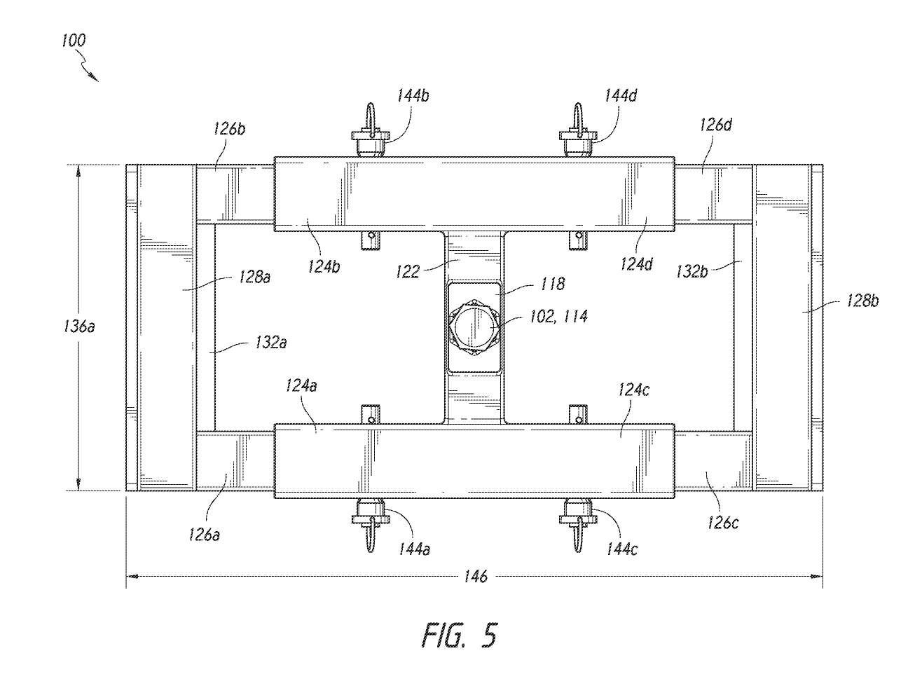

As illustrated in FIGS. 2 and 5, the frame 106 can include a central portion 122 (e.g., a hub). In some embodiments, the connection interface 118 is positioned on or in the central portion 122. The frame 106 can include one or more attachment interfaces configured to connect to the one or more attachment members 108a, 108b. For example, as illustrated, the frame 106 can include a plurality of arms 124a, 124b, 124c, 124d (hereinafter, collectively, arms 124). One or more of the arms 124 can be connected to the central portion 122 of the frame 106. In some embodiments, each of the arms 124 is connected to the central portion 122. For example, the arms 124 can be welded or otherwise affixed to the central portion 122. In some configurations, two or more of the arms 124 are parallel or substantially parallel to each other. For example, a first arm 124a can be parallel and spaced from a second arm 124b. The first and second arms 124a, 124b can form a first pair of arms. In some embodiments, a third arm 124c can be parallel and spaced from a fourth arm 124d. The third and fourth arms 124c, 124d can form a second pair of arms. In some configurations, the first and third arms 124a, 124c are collinear. For example, the first and third arms 124a, 124c can be formed from a single bar (e.g., a polygonal bar or round bar). In some configurations, the second and fourth arms 124b, 124d are collinear and/or formed from a single bar.

As illustrated in FIGS. 3-5, a first attachment member 108a (e.g., jaw or claw) can include one or more attachment interfaces configured to connect to the frame 106. For example, the first attachment member 108a can include a first mating arm 126a. In some embodiments, the first attachment member 108a includes at least two mating arms (e.g., first mating arm 126a and second mating arm 126b). The first and second mating arms 126a, 126b can be parallel and/or spaced from each other. In some embodiments, a space between the first and second mating arms 126a, 126b (e.g., a distance between the respective centerlines of the arms 126a, 126b) is equal to or substantially equal to the space between the first and second arms 124a, 124b (e.g., a distance between the respective centerlines of the arms 124a, 124b). In some configurations, the first attachment member 108a includes an attachment hub 128a. The attachment hub 128a can be connected to one or more of the mating arms 126a, 126b of the first attachment member 108a. The attachment hub 128a can be, for example, a bar or other elongate structure.

As illustrated, the first attachment member 108a can include a spacer 130a. The spacer 130a can be connected to one or more of the attachment hub 128a and the mating arms 126a, 126b. The spacer 130a can be, for example, an elongate and/or flattened portion of material. The spacer 130a can extend away from the attachment hub 128a in a direction generally parallel to the actuation axis 120 away from the head 114 (e.g., downward in the frame of reference of FIG. 3). In some configurations, the spacer 130a extends away from the attachment hub 128a in a direction at least partially away from the actuation axis 120 (e.g., to the left in the frame of reference of FIG. 3). In some embodiments, the spacer 130a includes at least one cut out portion (not shown). Including one or more cut out portions on the spacer 130a can reduce the weight of the spacer 130a. In some configurations, the first attachment member includes more than one spacer 130a.

As illustrated in FIG. 3, the first attachment member 108a can include one or more gripping or clasping portions configured to grasp at least a portion of an impeller. For example, the first attachment member 108a can include a grasping portion 132a. The grasping portion 132a can be, for example, one or more flattened and/or elongate structures extending from the spacer 130a and/or from the one or more arms 126a, 126b. In some configurations, the grasping portion 132a is a flattened structure extending toward the actuation portion 102 from the spacer 130a in a direction generally perpendicular to the actuation axis 120. In some embodiments, use of multiple arms 124, 126 for each grasping portion 132a, 132b can reduce the overall weight of the device 100 while maintaining a high degree of strength and structural integrity of the device 100.

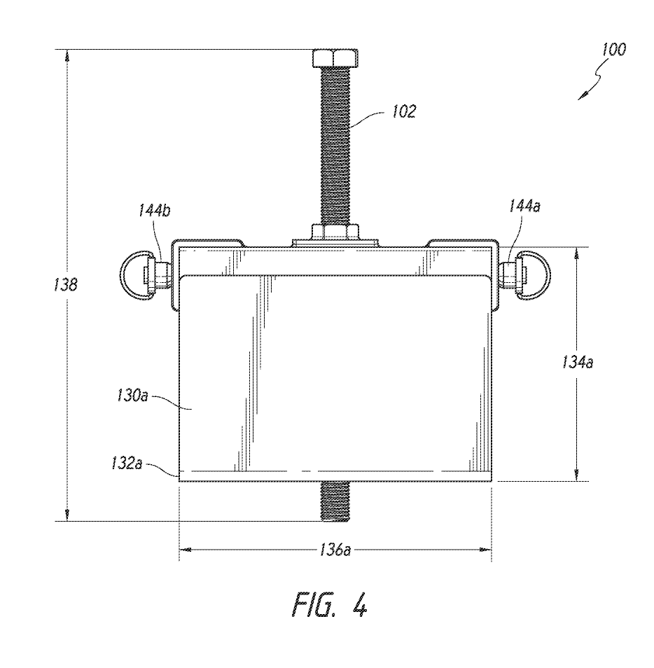

As illustrated in FIG. 4, the first attachment member 108a can have a height 134a that is less than or equal to a width 136a of the attachment member 108a (e.g., the width of the grasping portion 132a), as measured in a plane perpendicular or generally perpendicular to a central axis of the first mating arm 126a (e.g., in the plane of the sheet of FIG. 4). For example, the height 134a can be less than 9/10, less than 8/9, less than ¾, less than ⅝, and/or less than ½ of the width 136a of the spacer 130. In some embodiments, the height 134a of the first attachment member 108a is approximately ⅔ of the width 136a of the attachment member 108a.

In some embodiments, a length 138 of the actuation member 102 can be greater than the height 134a of the first attachment portion 108a. For example, the length 138 of the actuation member 102 can be greater than 1.1 times, greater than 1.25 times, greater than 1.4 times, and/or greater than 1.7 times the height 134a of the first attachment portion 108a. In some configurations, the length 138 of the actuation member 102 is approximately 1.5 times the height 134a of the first attachment portion 108a. Having an actuation member 102 that is longer than the first attachment portion 108a is tall can facilitate a range of operation in the direction parallel to the actuation axis 120 great enough to completely remove an impeller from an axel.

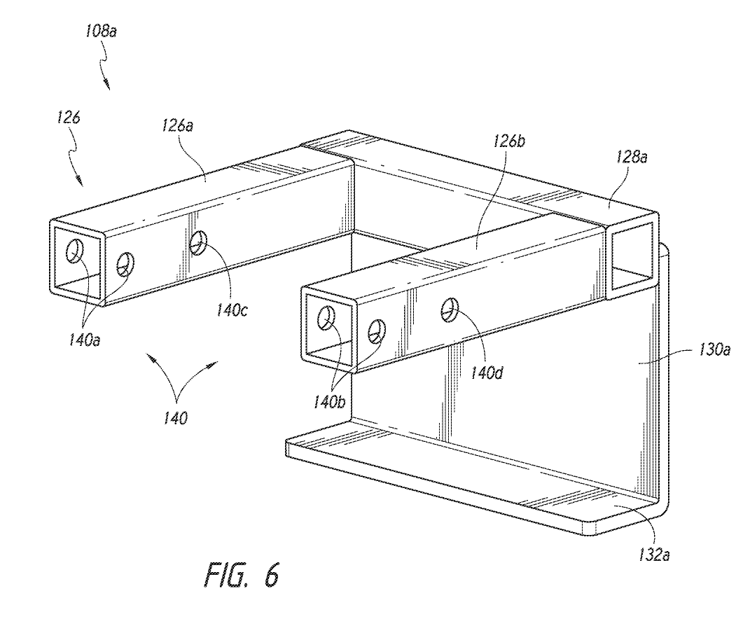

As illustrated in FIG. 6, the first attachment member 108a can include one or more mating features configured to facilitate connection between the first attachment member 108a and the frame 106. For example, one or both of the arms 124b can include one or more mating structures configured to facilitate releasably and/or adjustably mating with one or more of the arms 124 of the frame 106. As illustrated, each of the mating arms 124a, 124b includes at least one set of apertures 140a-d. For example, a first pair of holes 140a can extend through the walls of the first mating arm 126a. The pair of holes 140a can be collinear with each other. The second mating arm 126b can include a second pair of holes 140b extending through the walls of the second mating arm 126b. In some embodiments, the second pair of holes 140b is collinear with the first pair of holes 140a. The pairs of holes 140a, 140b can be sized and positioned to align with corresponding pairs of holes 142a, 142b (FIG. 2) in the walls of the arms 124a, 124b of the frame 106. Pins 144a, 144b can be inserted through the holes 140a, 142a and 140b, 142b, respectively. As illustrated in FIG. 6, the mating arms 126a, 126b can include additional pairs of holes 140c and 140d, respectively, to facilitate mating of the mating arms 126a, 126b, with the arms 124a, 124b in more than one position as measured along the central axes of the mating arms 126a, 126b.

Each of the features of the first attachment portion 108a as described above can be found in the second attachment portion 108b, as indicated by the common reference numbers used with respect to the second attachment portion 108b (e.g., spacer 130a v. spacer 130b, mating arms 126a-b v. mating arms 126c-d, grasping portion 132a v. grasping portion 132b, etc.).

Adjustability of the mating arms 126a, 126b with the arms 124a, 124b of the frame 106 can facilitate widening or narrowing of the attachment portions 108a, 108b with respect to each other. For example, as illustrate in FIG. 5, the device 100 can have an overall width 146 (e.g., a distance between the spacers 130a, 130b) greater than the width 136a of the spacers 130a, 130b. The width 146 can be adjusted by changing the alignment of the holes 140 of the mating arms 126 with the holes 142 of the arms 124. In some embodiments, the attachment portions 108a, 108b include structure (e.g., gaskets, sleeve, friction-features) configured to facilitate an infinite number of variations for the width 146.

A method of manufacturing the impeller remover device 100 can include connecting (e.g., welding and/or adhering) the arms 124 to the central portion 122 to form the frame 106. The method can include drilling or otherwise forming a hole in the central portion 122 to accommodate the connection interface 118 and/or the actuation portion 102. In some embodiments, the method includes drilling one or more holes in the arms 124 to form mating holes for facilitating mating with the mating arms 126 of the attachment portions 108a, 108b.

The method of manufacture can include connecting (e.g., welding and/or adhering) attachment hubs 128a, 128b to mating arms 124a, 124b and 124c, 124d, respectively. In some embodiments, the method includes connecting a spacer 130a, 130b to the mating arms and/or to the attachment hubs. The method can include forming a grasping portion 132a, 132b on and/or attaching a grasping portion 132a, 132b to the spacers and/or to the mating arms. For example, the spacers can be bent to form the grasping portions. In some embodiments, the grasping portions are welded or otherwise connected to the spacers. One or more holes or pairs of holes 140 can be formed in the walls of the mating arms 124.

The method of manufacture can include connecting the attachment portions 108a, 108b to the frame 106 via pins or other structures (e.g., via use of the holes and pins as described above). In some embodiments, the attachment portions 108a, 108b are connectable to the frame 106 in a plurality of positions to vary the width 146 of the device 100.

The method of manufacture can include adjustably mating the actuating portion 102 with the frame 106. For example, the actuating portion 102 can be threadedly engaged with the connection interface 118 or with some other mating structure of the frame 106 and/or central portion 122 of the frame 106.

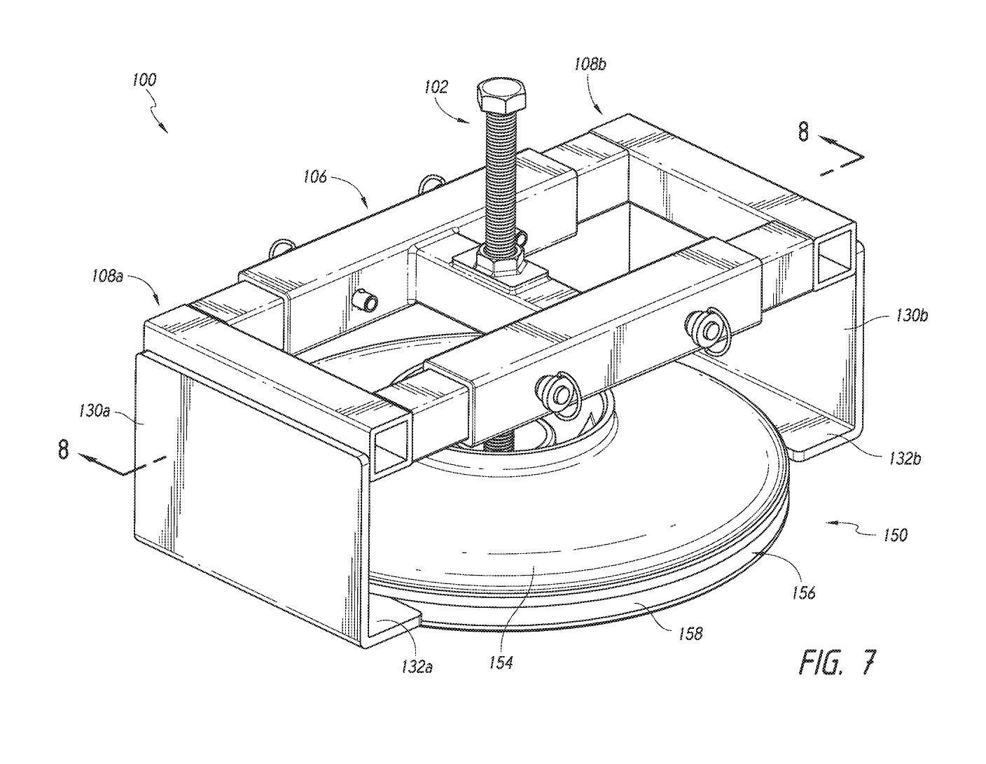

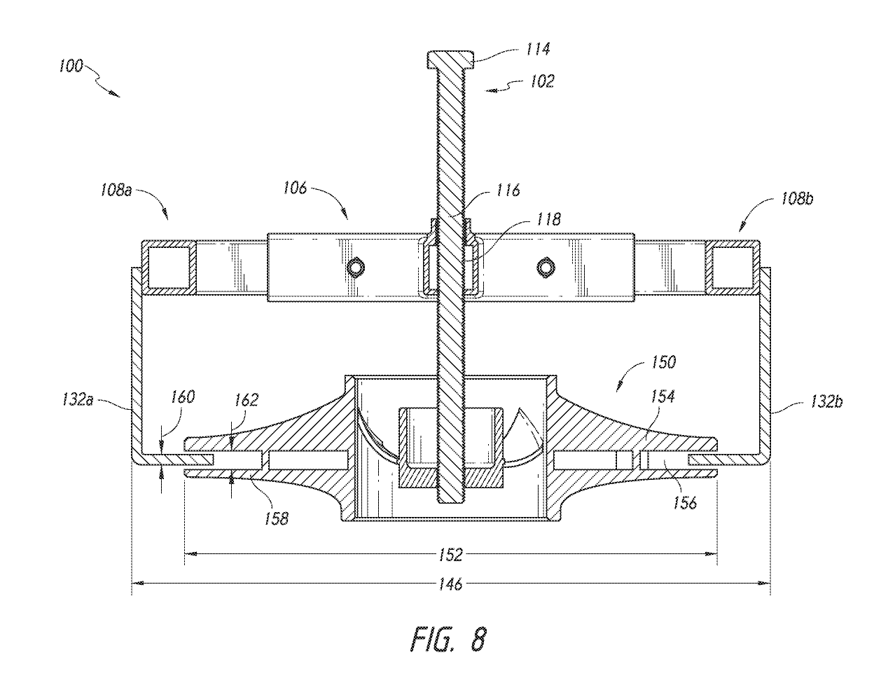

In some embodiments, a method of removing an impeller 150 from an industrial assembly (e.g., from an axel) can include setting a width 146 of the device 100 to be greater than a diameter 152 of the impeller 152, as illustrated in FIGS. 7-9. The method can include inserting the grasping portions 132a, 132b of the attachment portions 108a, 108b behind a front vane 154 of the impeller 150. In some embodiments, the method includes inserting the grasping portions 132a, 132b into a gap 156 between the front vane 154 and a back vane 158 of the impeller 150. To facilitate insertion of the grasping portion 132a, 132b into the gap 156, the grasping portions can have a thickness 160 less than a width 162 of the gap 156.

The step of inserting the grasping portions 132a, 132b into the gap 156 can include sliding the device 100 parallel to the width 136a of the attachment members 108a, 108b. In some embodiments, the step of inserting the grasping portions 132a, 132b into the gap 156 can include moving the attachment members 108a, 108b closer to each other to inserting grasping portions 132a, 132b into the gap 156 in a direction perpendicular to the width 136a of the attachment members 108a, 108b.

The method of removing the impeller 150 from an axel (not shown) or other industrial assembly component can include actuating the actuation portion 102 via use of a tool or other user input. The step of actuating the actuation portion 102 can include moving the actuation portion 102 toward the impeller 150 (e.g., via rotation of the actuation portion 102) with respect to the frame 106. The actuation portion 102 can brace against or abut the axel of the impeller 150. Further movement of the actuation portion 102 toward the impeller 150 can “pull” the grasping portions 132a, 132b into contact with a back side of the front vane 154 of the impeller 150. Such pulling can pull the impeller 150 with respect to the axel to remove the impeller 150 from the axel.

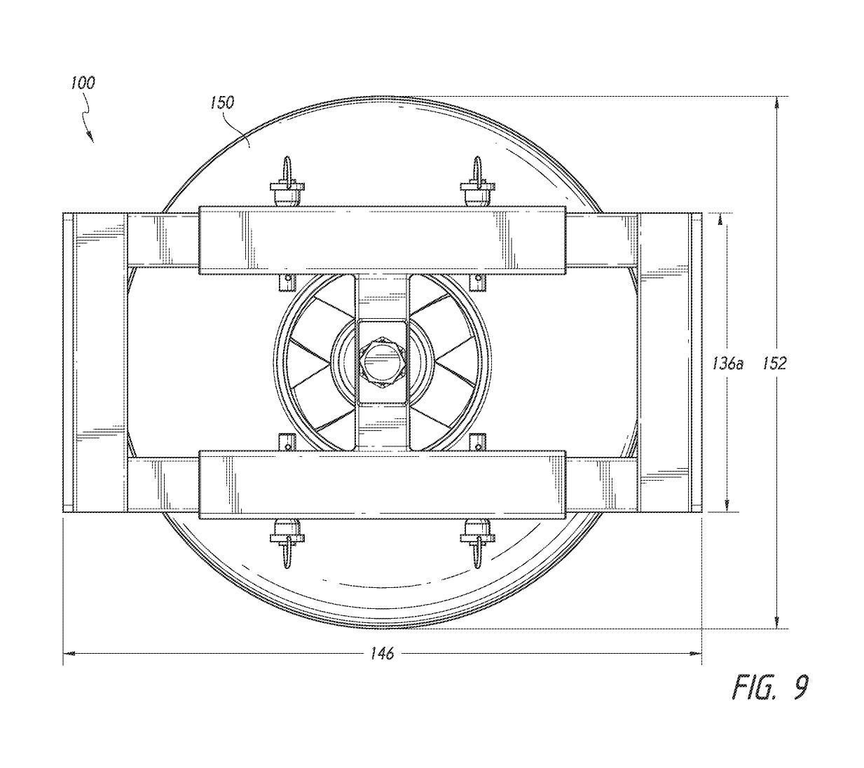

As illustrated in FIG. 9, the width 136a of the spacers and grasping portions can be greater than ¼, greater than ⅓, greater than ½, and/or greater than ¾ of the diameter 152 of the impeller 150 (e.g., the width of the device 146). For example, the width 136a of the grasping portions can be approximately 11/20 of the diameter of the impeller 150 (e.g., the width of the device 146). Having wide grasping portions in comparison to the diameter of the impeller can increase the area of contact between the grasping portions and the back side of the front vane 154 of the impeller 150. Increasing this area of contact can reduce the risk of breaking the impeller 150 via, for example, cracking or otherwise breaking the front vane 154 of the impeller 150.

In some applications, it can be advantageous to loosen and/or begin removal of the impeller 150 prior to and/or in conjunction with use of the impeller remover device 100 described above. In some such cases, use of a wedge or other device to apply a pushing force on the back surface of the back vane 158 can be advantageous.

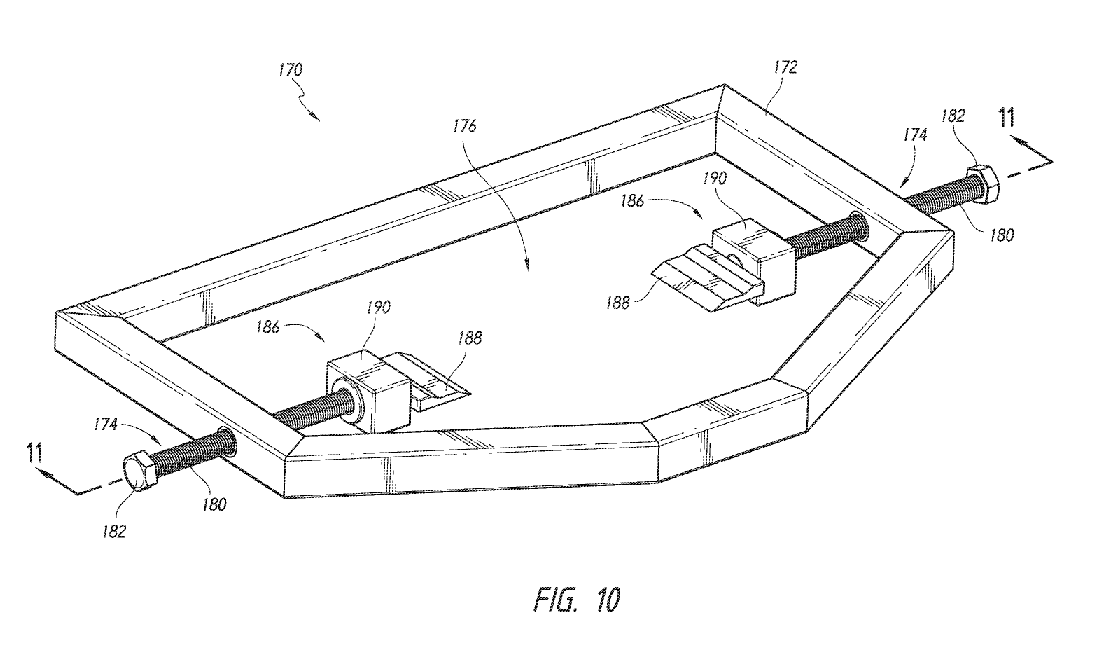

FIGS. 10-12 illustrate a wedging device 170 which can be used to applying a force to the back side of the back vane 158 of the impeller 150. As illustrated, the wedging device 170 can include a frame 172. One or more wedge members 174 can be connected to the frame 172. For example, as illustrated, the device 170 can include two wedge members 174.

In some cases, the frame 172 is constructed from rods welded or otherwise connected to each other. For example, the frame 172 can be constructed from hollow rods (e.g., square rods, round rods, or otherwise).

The frame 172 can have a perimeter defining a frame opening 176. The frame opening 176 can be sized and shaped to permit movement of the device 170 around and behind the impeller 150 from a front side of the impeller 150. In some configurations, the frame 172 is sized and shaped to permit movement of the device 170 around and behind the impeller 150 and remover device 100 when the remover device 100 is attached to the impeller 150.

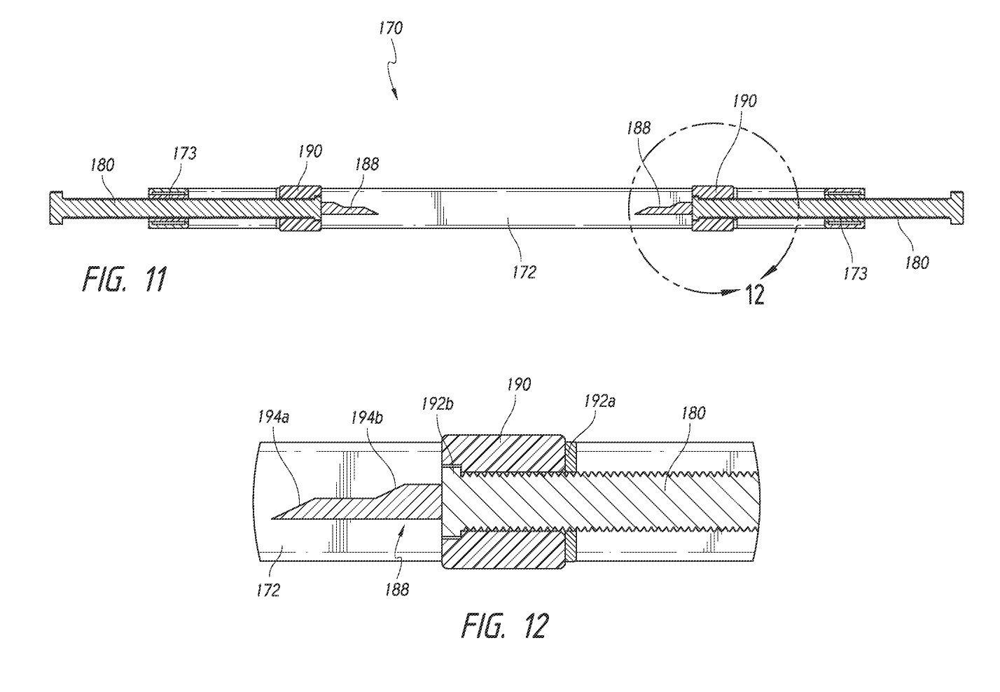

As illustrated, wedge members 174 can include a wedge actuation portion 180. The wedge actuation portion 180 can be, for example, a rod or other elongate member. In the illustrated example, the wedge actuation portion 180 is an externally-threaded rod. The external threading on the wedge actuation portion 180 can extend along a portion, a majority, and/or an entirety of a length of the wedge actuation portion 180. The external threads of the wedge actuation portion 180 can be configured to engage with internal threads 173 in a portion of the frame 172 (FIG. 11). Threaded engagement (e.g., and/or frictional engagement) between the wedge actuation portion 180 and the frame 172 can facilitate controlled and/or load-bearing movement between the wedge actuation portion 180 and the frame 172 in a direction parallel to the length of the wedge actuation portion 180.

The wedge actuation portion 180 can include a head 182 or other structure configured to receive user input via a tool (e.g., a wrench, a drill, a pneumatic tool, etc.) or otherwise. For example, the head 182 can be a hex head or other standard head configured to receive rotational input (e.g. torque) from a tool.

The wedge members 174 can include wedging portions 186. The wedging portions 186 can be positioned at or near an end of the wedge members 174 opposite the heads 182. The wedging portions 186 can be configured to fit at least partially behind the back surface of the back vanes 158 of the impeller 150 before or during removal of the impeller 150 from an axel or other structure.

In some embodiments, the wedging portions 186 include an insertion portion 188. The insertion portion 188 can be sized and shaped to fit at least partially behind the back surface of the back vanes 158 of the impeller 150 before or during removal of the impeller 150 from an axel or other structure. The wedging portions 186 can include a wedge connection interface 190. The wedge connection interface 190 can be fixedly connected to, moveably connected to, rotatably connected to, or formed as a monolithic part with the insertion portion 188.

The wedge connection interface 190 can be connected to the wedge actuation portion 180. For example, as illustrated in FIGS. 11 and 12, the wedge actuation portion 180 can extend at least partially into the wedge connection interface 190. The wedge actuation portion 180 can include one or more abutment portions 192a, 192b. For example, a first abutment portion 192a can comprise a washer or other structure fixed to the wedge actuation portion 180 in a direction parallel to the length of the wedge actuation portion 180. The height and/or width of the wedge connection interface 190 can be sized to approximate the diameter or other cross-sectional width of the first abutment portion 192a. The abutment portion 192a can abut a surface of the wedge connection interface 190 to limit (e.g., stop) movement of the wedge actuation portion 180 in a direction toward the insertion portion 188 with respect to the wedge connection interface 190. A second abutment portion 192b can be connected to the wedge actuation portion 180. For example, the second abutment portion 192b can be connected to the wedge actuation portion 180 along the length of the wedge actuation portion 180 further from the head 182 than the first abutment portion 192b. The second abutment portion 192b can be a washer or other structure configured to abut the wedge connection interface 190 and limit (e.g., stop) movement of the wedge actuation portion 180 in a direction toward the head 182 with respect to the wedge connection interface 190. Alone or in combination, the abutment portions 192a, 192b can inhibit or prevent movement of the wedge actuation portion 180 in a direction parallel to the length of the wedge actuation portion 180 when the wedge members 174 are moved toward and away from the impeller 150. In some embodiments, the wedge actuation portion 180 can rotate freely (e.g., without threaded engagement) within the wedge connection interface 190.

As illustrated in FIG. 12, the wedge insertion portion 188 can include at least one sloped surface. For example, the insertion portion can include a first sloped surface 194a. The first sloped surface 194a can be positioned on an end of the insertion portion 188 furthest from the head 182. The first sloped surface 194a can have a constant slope with respect to an axis of rotation of the wedge actuation portion 180. In some embodiments, the first sloped surface 194a can have a varying slope along a length of the first sloped surface 194a. The slope of the first sloped surface 194a can be less than 45 degrees, less than 55 degrees, less than 35 degrees, and/or less than 65 degrees. In some embodiments, the slope of the first sloped surface 194a with respect to the axis of rotation of the wedge actuation portion 180 is approximately 25 degrees.

The first sloped surface 194a can be inserted behind the back vane 158 of the impeller 150. As the surface 194a is inserted behind the back vane 158, the sloped surface 194a can push the impeller 150 in a direction toward the front vane 154 with respect to the back vane 158.

In some embodiments, the wedge insertion portions 188 include second sloped surfaces 194b. The second sloped surface 194b can be positioned between the first sloped surface 194a and the connection interface 190 and/or above (e.g., in the frame of reference of FIG. 12) the first sloped surface 194a. The second sloped surface 194b can have the same or similar characteristics (e.g., slope, length, etc.) as the first sloped surface 194a.

For expository purposes, the term “horizontal” as used herein is defined as a plane parallel to the plane or surface of the floor of the area in which the device being described is used or the method being described is performed, regardless of its orientation. The term “floor” floor can be interchanged with the term “ground.” The term “vertical” refers to a direction perpendicular to the horizontal as just defined. Terms such as “above,” “below,” “bottom,” “top,” “side,” “higher,” “lower,” “upper,” “over,” and “under,” are defined with respect to the horizontal plane.

The terms “approximately”, “about”, “generally” and “substantially” as used herein represent an amount close to the stated amount that still performs a desired function or achieves a desired result. For example, the terms “approximately”, “about”, “generally,” and “substantially” may refer to an amount that is within less than 10% of the stated amount.

As used herein, the terms “attached,” “connected,” “mated,” and other such relational terms should be construed, unless otherwise noted, to include removable, moveable, fixed, adjustable, and/or releasable connections or attachments. The connections/attachments can include direct connections and/or connections having intermediate structure between the two components discussed.

Although the impeller remover and wedge tools have been disclosed in the context of certain embodiments and examples, it will be understood by those skilled in the art that the impeller remover and wedge tool extend beyond the specifically disclosed embodiments to other alternative embodiments and/or uses of the embodiments and certain modifications and equivalents thereof For example, some embodiments of the device 100 include attachment members having a single arm or more than two arms. Accordingly, it is intended that the scope of the impeller remover and wedge tool herein-disclosed should not be limited by the particular disclosed embodiments described above, but should be determined only by a fair reading of the claims that follow.

What is claimed is:

1. An impeller removal tool comprising:
a frame having:
a central portion;
a first arm connected to the central portion and extending therefrom; and
a second arm connected to the central portion and extending therefrom;
an actuation portion movably connected to the central portion of the frame, the actuation portion configured to engage with an axle of an impeller assembly; and
a first jaw having:
a first coupling portion configured to movably connect to the first arm of the frame;
a second coupling portion configured to movably connect to the second arm of the frame; and
a first jaw portion connected to both the first coupling portion and to the second coupling portion, the first jaw portion configured to fit at least partially between two walls of an impeller and to impart a force on a wall of an impeller to remove an impeller from an axle of an impeller assembly.

2. The impeller removal tool of claim 1, wherein:
the frame comprises:
a third arm connected to the central portion and extending therefrom; and
a fourth arm connected to the central portion and extending therefrom; and
the impeller removal tool comprises:
a second jaw having:
a third coupling portion configured to movably connect to the third arm of the frame;
a fourth coupling portion configured to movably connect to the fourth arm of the frame; and
a second jaw portion connected to both the third coupling portion and to the second coupling portion, the second jaw portion configured to fit at least partially between two walls of an impeller and to impart a force on a wall of an impeller to remove an impeller from an axle of an impeller assembly.

3. The impeller removal tool of claim 1, wherein the central portion of the frame includes a threaded opening, and wherein the actuation portion comprises a threaded rod portion configured to threadedly engage with the threaded opening of the central portion of the frame.

4. The impeller removal tool of claim 1, wherein the frame comprises an “H” shape, the first, second, third, and fourth arms extending perpendicularly from a length of the central portion.

5. The impeller removal tool of claim 4, wherein the first and third arms are collinear and the second and fourth arms are collinear.

6. The impeller removal tool of claim 1, wherein first and second coupling portions are configured to connect to the first and second arms, respectively, in at least a first position and a second position, wherein the first jaw portion is positioned closer to the center portion of the frame in the first position than in the second position.

7. The impeller removal tool of claim 2, wherein the third and fourth coupling portions are configured to connect to the first and second arms, respectively, in at least a first position and a second position, wherein the second jaw portion is positioned closer to the center portion of the frame in the first position than in the second position.

8. The impeller removal tool of claim 1, wherein the first and second arms each comprise a hollow bar.

9. The impeller removal tool of claim 2, wherein the third and fourth arms each comprises a hollow bar.

10. An impeller remover tool comprising
an actuation portion having:
an elongate body having a first end, a second end, and a length therebetween; and
a head on the first end of the elongate body;
a frame having:
a hub;
a first arm connected to and extending from the hub;
a second arm connected to the hub and extending from the hub; and
a connection interface connected to the hub and configured to mate with a portion of the elongate body of the actuation portion;
a first engagement portion having:
a first mating arm configured to mate with the first arm of the frame;
a first grasping portion configured to grasp at least a portion of an impeller; and
a first spacer connected to the first mating arm and to the first grasping portion, the first spacer distancing the first grasping portion from the first mating arm in a direction parallel to the length of the elongate body of the actuation portion; and
a second engagement portion having:
a second mating arm configured to mate with the second arm of the frame;
a second grasping portion configured to grasp at least a portion of an impeller; and
a second spacer connected to the second mating arm and to the second grasping portion, the second spacer distancing the second grasping portion from the second mating arm in a direction parallel to the length of the elongate body of the actuation portion;
wherein:
each of the first and second grasping portions has a width measured in a direction perpendicular to both the length of the elongate body and to the first arm of the frame; and
the width of each of the first and second grasping portions is greater than one half of a width of the removal tool in a direction parallel to the first arm when the removal tool is attached to an impeller.

11. The impeller remover tool of claim 10, comprising a third arm connected to and extending from the hub in a direction parallel to the first arm, wherein the first spacer is connected to the third arm.

12. The impeller remover tool of claim 11, comprising a fourth arm connected to the hub and extending from the hub in a direction parallel to the second arm, wherein the second spacer is connected to the fourth arm.

13. The impeller remover tool of claim 10, wherein the first grasping portion is formed by bending the first spacer.

14. The impeller remover tool of claim 10, wherein the first grasping portion is a flattened plate.

15. The impeller remover tool of claim 10, wherein:
the first arm comprises a pair of collinear holes extending therethrough;
the first mating arm comprises a pair of collinear holes extending therethrough;
the tool includes a pin extending through the pairs of collinear holes in both the first arm and the first mating arm; and
the pin inhibits movement of the first arm with respect to the first mating arm in a direction parallel to the first arm.

16. The impeller remover tool of claim 10, wherein the first and second grasping portions are each configured to fit between a front vane and a back vane of an impeller.

17. The impeller remover tool of claim 10, wherein the second end of the elongate body of the actuation portion is configured to contact an axel of an impeller when the remover tool is installed on an impeller.

18. An impeller removal system comprising:
the impeller removal tool of claim 1; and
a wedging device having:
a wedging frame defining a perimeter of the wedging device;
a first wedge member connected to the wedging frame and having:
a first wedge actuation portion having a first end, a second end, and a length therebetween; and
a wedging portion connected to the second end of the first wedge actuation portion, the wedging portion configured to fit behind a back vane of an impeller before or during removal of an impeller from an axel, the wedging portion having a sloped surface; and
a second wedge member connected to the wedging frame and having:
a second wedge actuation portion having a first end, a second end, and a length therebetween; and
a wedging portion connected to the second end of the second wedge actuation portion, the wedging portion configured to fit behind a back vane of an impeller before or during removal of an impeller from an axel, the wedging portion having a sloped surface.

19. An impeller removal system comprising:
the impeller remover tool of claim 10; and
a wedging device having:
a wedging frame defining a perimeter of the wedging device;
a first wedge member connected to the wedging frame and having:
a first wedge actuation portion having a first end, a second end, and a length therebetween; and
a wedging portion connected to the second end of the first wedge actuation portion, the wedging portion configured to fit behind a back vane of an impeller before or during removal of an impeller from an axel, the wedging portion having a sloped surface; and
a second wedge member connected to the wedging frame and having:
a second wedge actuation portion having a first end, a second end, and a length therebetween; and
a wedging portion connected to the second end of the second wedge actuation portion, the wedging portion configured to fit behind a back vane of an impeller before or during removal of an impeller from an axel, the wedging portion having a sloped surface.
